(19) United States
(12) Patent Application Publication
(10) Pub. No.: US 2004/0213239 A1
(43) Pub. Date: Oct. 28, 2004

(54) Implementation of IP multicast on ATM network with EMCON links

(76) Inventors: Xinming A. Lin, Beaverton, OR (US); William J. Sutton, Salt Lake City, UT (US); Michael L. Mitchell, Park City, UT (US); John W. Love, Bountiful, UT (US); Daniel G. Watt, West Jordan, UT (US)

Correspondence Address: Geza C. Ziegler, Jr, PERMAN & GREEN, LLP, 425 Post Road, Fairfield, CT, 06430, US

(21) Appl. No.: 09/739,549

(22) Filed: Dec. 15, 2000

(51) Int. Cl. H04L 12/56

(52) U.S. Cl. 370/395.1; 370/401

(57) ABSTRACT

An asynchronous transfer mode communications network comprising a first communications platform, a second communications platform and an emission control communications link coupling the first and second communications platforms. The network is adapted to provide multicast connections between the first platform and the second platform when the network is in an emission control (EMCON) state.

### BACKGROUND OF THE INVENTION

1. Field of the Invention

The present invention relates to communication systems and, more particularly, to an asynchronous transfer mode communication network.

2. Brief Description of Related Developments

In an asynchronous transfer mode (“ATM”) communication system or network where nodes join and leave dynamically, communication is normally through switched virtual circuits (“SVC”). SVC's generally rely on bi-directional signaling channels to stay active. When communication links go into an emission controlled (“EMCON”) mode, this bi-directional signaling channel can no longer be maintained, and SVC's are normally cleared. It would be helpful to be able to support internet protocol (“IP”) multicasting and end-to-end quality of service (“QOS”) in an asynchronous transfer mode network with EMCON links.

### SUMMARY OF THE INVENTION

The present invention is directed to, in a first aspect, an asynchronous transfer mode communications network. In one embodiment, the network comprises a first communications platform, a second communications platform and an emission control communications link coupling the first and second communications platforms. The network is adapted to provide multicast connections between the first platform and the second platform when the network is in an emission control (EMCON) state.

In a second aspect, the present invention is directed to a communications network. In one embodiment, the network comprises a first communications cluster and a second communications cluster. The first cluster is coupled to the second cluster by an EMCON data link. During EMCON operation, the first cluster is adapted to forward multicast data over the EMCON data link to the second cluster, and the second cluster is adapted to transmit the data to surface multicast members.

### BRIEF DESCRIPTION OF THE DRAWINGS

The foregoing aspects and other features of the present invention are explained in the following description, taken in connection with the accompanying drawings, wherein:

FIG. 1 is a block diagram of an asynchronous transfer mode communications system.

FIG. 2 is a block diagram of an asynchronous transfer mode communications system incorporating features of the present invention.

FIG. 3 is a table of an example of an EMCON specific capabilities Information group for a system incorporating features of the present invention.

FIG. 4 is a table of an example of MARS-specific system capabilities for a system incorporating features of the present invention.

FIG. 5 is a table of an example of an ARP-specific System capabilities group for a system incorporating features of the present invention.

### DETAILED DESCRIPTION OF THE PREFERRED EMBODIMENT

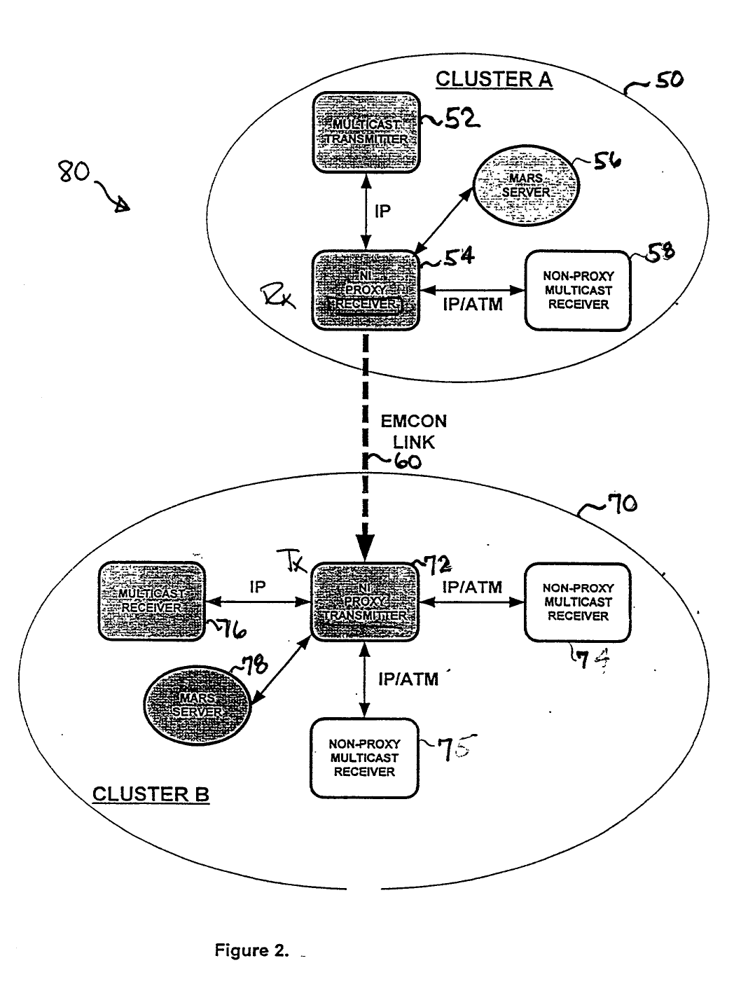

Referring to FIG. 2, there is shown a block diagram of a system 80 incorporating features of the present invention. Although the present invention will be described with reference to the embodiments shown in the drawings, it should be understood that the present invention can be embodied in many alternate forms.

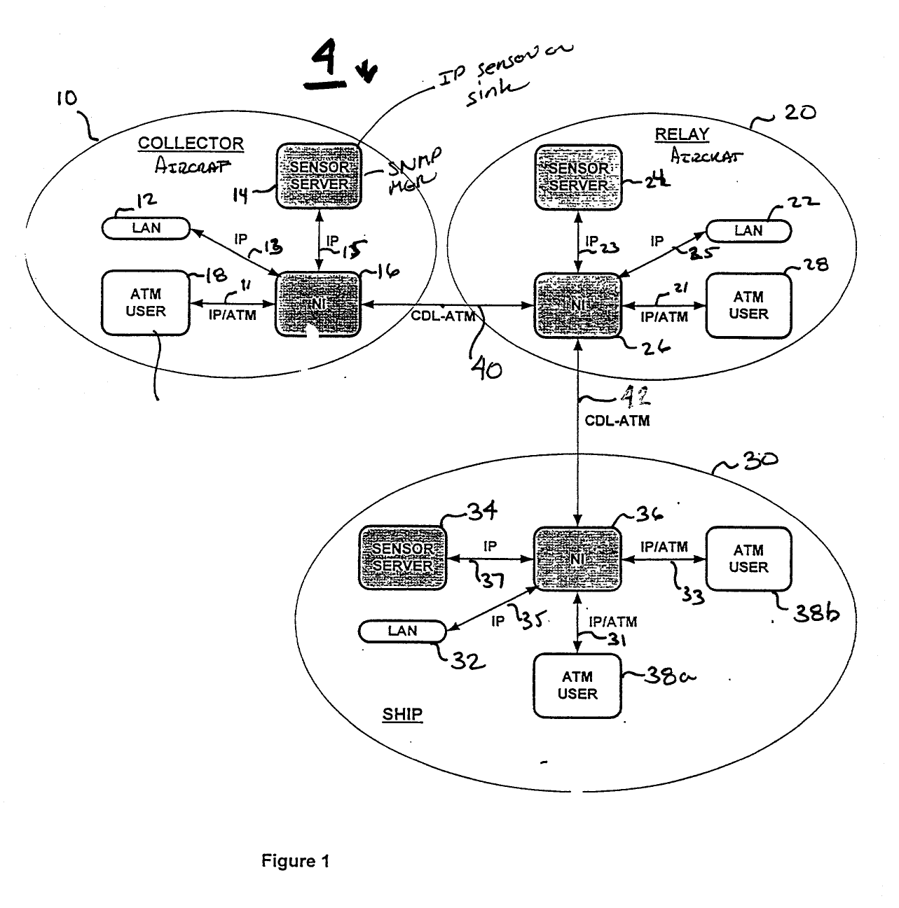

A model of an asynchronous transfer mode communications network 4 is shown in FIG. 1. The system 4 can comprise a first platform 10, a second platform 20 and a third platform 30. A common data link-asynchronous transfer mode (“CDL-ATM”) link 40 can be used to couple platforms 10 and 20. A similar CDL-ATM link 42 can couple platforms 20 and 30. The links 40 and 42 are generally bi-directional links capable of supporting messages both to and from platform 30.

In FIG. 1, the second platform 20 generally comprises a “Relay” platform. The “Relay” platform can provide sensor collection. The first platform 10 is generally a “Collection” platform and can also provide sensor collection. Standard commercially available protocols can be used for all sensor data distribution requirements in the system 4.

For example, platform 10 could include a sensor server 14, a network interface (“NI”) 16, an ATM user 18, and a Local Area Network (“LAN”) 12. Each sensor server 14 generally comprises a sensor suite and can include an IP sensor source or sink, and a simple network manager protocol (“SNMP”) manager.

The network interface 16 generally comprises an ATM network device and can include for example, an ATM interface, an Ethernet LAN interface and an internal packet interface via backplane. Each network interface 16 can also incorporate a CLIP client, a MARS client, an SNMP agent and SNMP management information base (“MIB”), a Private Network-Network Interface (“PNNI”) and a PNNI Augmented Routing (“PAR”). In alternate embodiments each network interface 16 could include other suitable network communication devices, such as for example, an Address Resolution Protocol (“ARP”) server, and a Multicast Address Resolution Server (“MARS”) server.

The ATM user 28 is generally an attached user and can include for example a CLIP client, a MARS client and a SMNP agent. The LAN 22 generally comprises an Ethernet 100BaseT Local Area Network interface. In alternate embodiments, the LAN could include sensor sources or sinks, IP multicast capability or SNMP.

The “Relay” platform 20 is also adapted to provide a network relay function on the CDL-ATM link. Generally, the first and second platform 10, 20 represent airborne systems while the third platform 30 can represent a ship, or an ocean or surface platform. Generally, normal procedures and network configurations would result in a single MARS server that is resident, somewhere by election, in the collection, relay or ship platforms.

As shown in FIG. 2, the system 80 generally comprises a first platform 50 and a second platform 70. A link 60 is used to couple the first platform 50 to the second platform 70. The first platform 50 can generally be described as a “relay” platform, similar to the relay platform 20 shown in FIG. 1. The platform 70, also referred to as “Cluster B”, can generally be considered equivalent to the “Ship” platform 30 of FIG. 1.

The system 80 is generally adapted to provide internet protocol (“IP”) multicasting continually supported by end-to-end ATM connections in a network with EMCON links, which cannot be supported by systems such as the system 4 shown in FIG. 1.

When the state of the “Ship” platform 30 of FIG. 1 enters an emission control (“EMCON”) mode, the bi-directional CDL-ATM link 42 becomes the uni-directional EMCON LINK 60 shown in FIG. 2. In the embodiment shown in FIG. 2, the platform 50 transmits and the platform 70 receives. Platform 70, also referred to as cluster B, does not transmit, which is the EMCON state or condition. Consequently, platform 50 does not receive, even though it is “listening”.

As shown in FIG. 2, both platform 50 and platform 70 each include a multicast address resolution server (“MARS”) 56 and 78, respectively. The multicast address resolution server generally provides internet protocol multicasting over asynchronous transfer mode networks, but requires a bi-directional signaling channel, such as for example, a common data link. In an emission EMCON state, this bi-directional signaling channel cannot be maintained. As shown in FIG. 2, by adding a proxy receiver 54 and a proxy transmitter 72, the ATM network with EMCON links can still use standard networking protocols to provide multicast connections through the links.

Since the two platforms 50, 70 cannot communicate with standard protocols requiring message transfer in both directions, the EMCON link 60 is generally uni-directional and each platform 50, 70 operates independently. Each platform 50, 70 elects a MARS server within the platform where bi-directional communication is possible, and standard protocols function.

The network interface 26 of the Relay platform 20 of FIG. 1 assumes a new function in the system 80 shown in FIG. 2. In FIG. 1, the NI 26 generally comprises an ATM network device. In the system 80 shown in FIG. 2, the network interface becomes a NI Proxy Receiver 72. As proxy receiver 72, it can be adapted to accept multicast streams available from platform 50 and forward them across the uni-directional EMCON link 60 to platform 70.

The “Ship” platform 30 of FIG. 1 generally assumes a new function in the system 80 of FIG. 2 and becomes the NI Proxy Transmitter 72 of platform 70. The proxy receiver 54 will forward or transmit multicast data down the EMCON link 60 to the transmitter 72, which acts as a “proxy” transmitter on the surface cluster 70. As a proxy transmitter it is adapted to accept multicast streams received from the EMCON link 60 and registers them with the MARS server 78 so that the elements (74, 75 and 76) with platform 70 that require these multicast streams can receive them. As far as the elements 74, 75, 76 in platform 70 are concerned, it is the NI proxy transmitter 72 that is the source of the multicast streams.

In the embodiment shown in FIG. 2, the proxy transmitter 72 is generally a member of the surface multicast MARS cluster, which is generally the collection of equipment that registers with and uses the services of the MARS server. In FIG. 2, this is elements or members 72, 74, 75 and 76. Generally, the proxy transmitter 72 relays the multicast data from the proxy receiver 54 to the surface multicast members 74, 75, 76 through ATM switch connections.

Generally, a receiver of multicast data, such as for example receivers 74, 75, or 76, registers with the MARS server 78 and joins the multicast groups it is interested in. For example, referring to FIG. 2, the transmit side 50 of the EMCON link 60, after consultation with the PNNI topology database, can detect that the link 60 is in EMCON mode and that there are no other valid paths from the receiver side 70 to the transmit side 50 of the EMCON link through the network. This can trigger a request by proxy receiver 54 to join a pre-configured block of multicast group addresses, acting in proxy receiver 54. The selection field of the ATM address for the proxy receiver 54 can be for example, 0×FF, and non-proxy receivers 58 shall have values other than 0×FF as the selector field. Once the data path leaves EMCON mode, or a new, full duplex path opens within the network that provides connectivity, the proxy receiver 54 can leave the block of multicast group addresses. However, the proxy receiver 54 can continue to maintain any existing point-to-multipoint connections until a threshold of idle time is reached or the originator 52 of the multicast stream explicitly releases the connections.

In one embodiment, referring to FIG. 2, a multicast transmitter 52 can register with the MARS server 56 and request the cluster (multicast group) members registered to receive its multicast stream. Generally, the proxy receiver 54 will register with MARS server 56 to receive the multicast stream and will be part of the cluster (multicast group). Multicast transmitter 52 consults the coverage database made available by PNNI Augmented Routing (PAR) to determine if a particular cluster member can be added to the point-to-multipoint connection for the multicast stream.

Similarly, proxy transmitter 72 can register with MARS server 78 and request cluster (multicast group) members registered to receive multicast streams received via EMCON link 60 from proxy receiver 54. Proxy transmitter 72 consults the coverage database made available by PNNI Augmented Routing to determine if a particular cluster member can be added to a point-to-multipoint connection for a supported multicast stream.

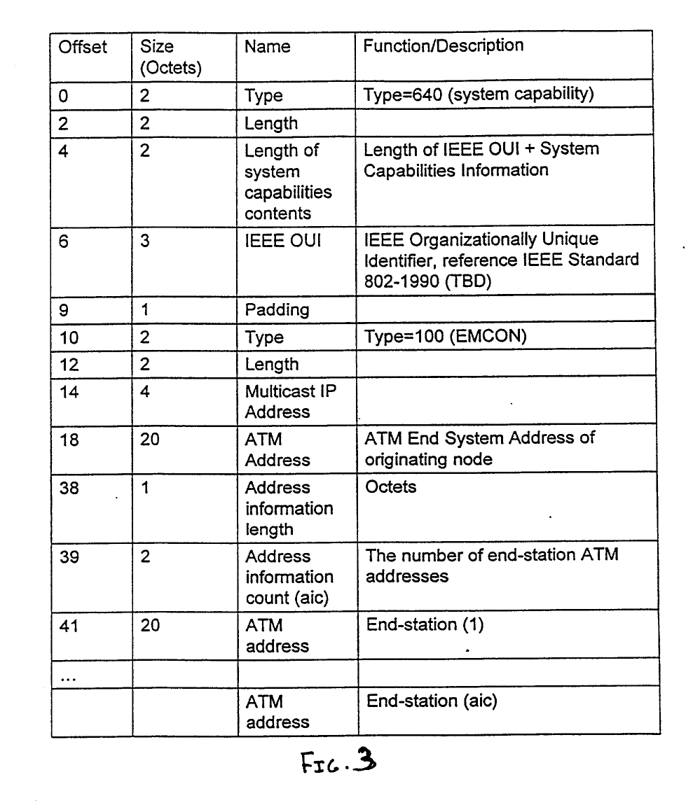

The “coverage database” is generally a collection of PNNI topology state elements (“PSTE”) that describe the end-stations of point-to-multipoint connections. Each point-to-multipoint connection is specified in an EMCON-specific capabilities group such as those shown in the table of FIG. 3. A cluster member generally should not be added to a point-to-multipoint connection if it is an end-station of another point-to-multipoint connection of the same multicast IP address and originating ATM address. Generally, when a non-proxy receiver, such as for example receiver 58 or 74 is added to a point-to-multipoint connection, standard protocol is followed.

When a proxy receiver 54 receives a point-to-multipoint connection set-up message or an add-party message, in order to begin multicast transfer operation, the proxy receiver 54 will respond with a connect or add-party acknowledgement message to multicast transmitter 52 for example. Additionally, the proxy receiver 54 can issue an (Interim Local Management Interface “ILMI”) set request to an enterprise specific management information base (“MIB”) multicast table for every T (TBR) seconds down any EMCON link that it is acting as a proxy for.

The ILMI set request messages can continue periodically until the proxy receiver leaves the block of multicast group addresses due to removal of EMCON.

The enterprise-specific MIB multicast table can contain variables for multicast IP address, calling party ATM address (originator), and connection ID (Virtual Path Identifier (VPI) and Virtual Channel Identifier (VCI)).

The multicast IP address can be included in a Broadband High Layer information element in the SETUP or ADD-PARTY messages sent by the originator. The proxy receiver 54 can establish a point-to-multipoint connection within the NI 54 shown in FIG. 2 from the incoming port to all EMCON ports that it is acting as a proxy for.

In FIG. 2, when the surface receive side 70 of an EMCON link receives the ILMI SetRequests to the enterprise-specific MIB multicast table, it acts as a proxy transmitter 72 for the originator.

Referring to FIG. 2, the server election process that occurs when disjoint clusters join due to removal of the EMCON restriction can comprise a MARS election algorithm.

Generally, each cluster 50, 70, elects a MARS 56, 78 through PNNI Augmented Routing (“PAR”). PAR is a major component of mobility operations and is an enhancement to PNNI to carry non-ATM (IP) information across all PAR capable switches within an ATM network. This allows IP capable end stations “visibility” of each other across the ATM cloud. The PAR can facilitate discovery and election of end stations providing IP services (servers) such as the ATM ARP server and the MARS server during dynamic topology changes.

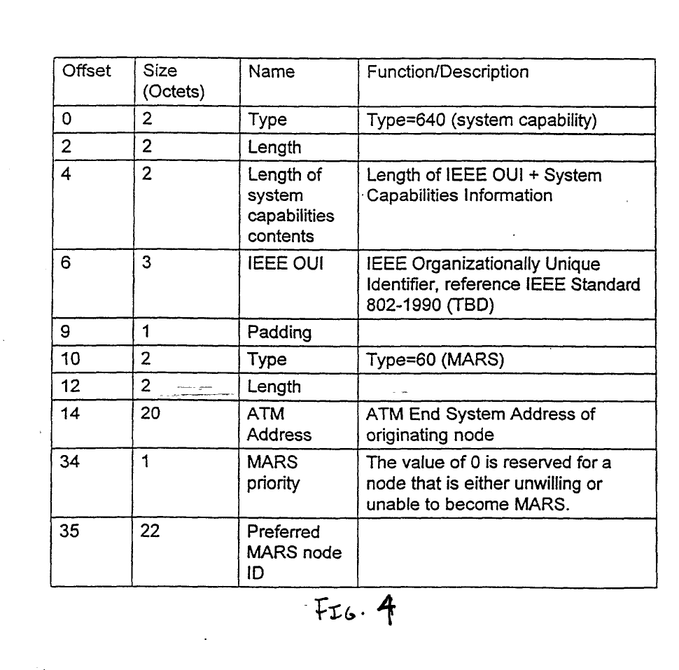

The election algorithm can be the same as a Peer Group Leader Election Algorithm in PNNI, except that it acts on “MARS Priority” in a MARS-specific System Capabilities Information Group instead of “Leadership Priority” in the Nodal Information Group. An example of one format of a MARS-specific System Capabilities Information Group is shown in the table of FIG. 4.

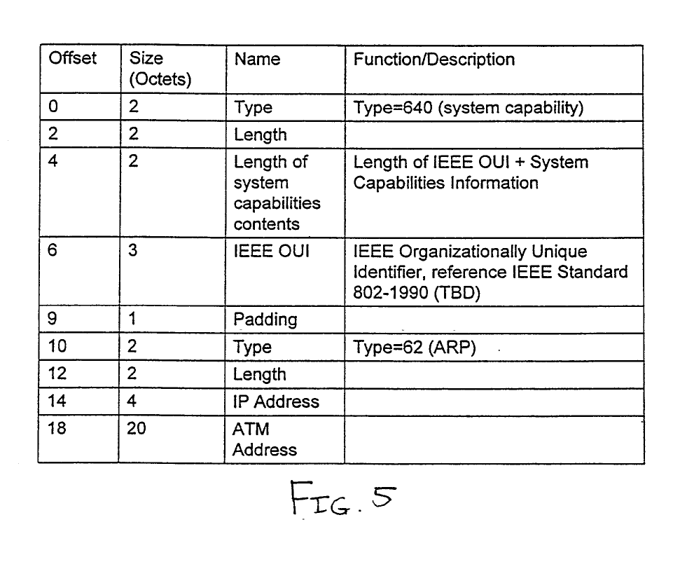

Referring to FIG. 1, each NI 16, 26 and 36 generally maintains a table of ATM Address Resolution Protocol (“ARP”) entries and responses to ATM ARP requests as a result of ARP-specific PAR. Generally, each ATM ARP entry can be carried in an ARP-specific System Capabilities Information Group, an example of which is shown in the table of FIG. 5.

When multiple clusters join into one, a new MARS is elected, which may or may not be among the old MARS. All registered MARS clients that detect a change of MARS can complete a “hard-redirect”, i.e., they can re-register and re-validate with the new MARS. Any existing point-to-multipoint connections are maintained until a threshold of idle time is reached or the originator initiates the release.

Similarly when one cluster is split into multiple clusters, each new cluster elects a new MARS. All registered MARS clients that detect a change of MARS can complete a “hard-redirect”, i.e., they can re-register and re-validate with the new MARS. Any existing point-to-multipoint connections are maintained until a threshold of idle time is reached or the originator initiates the release.

The present invention provides for the continued support of IP multicasting by end-to-end ATM connections in a network with EMCON links using standard networking protocols and special proxy receivers and proxy transmitters. PNNI Augmented Routing can be used to dynamically locate and configure multicast address resolution servers and address resolution protocol servers.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An asynchronous transfer mode communications network comprising:
a first communications platform;
a second communications platform; and
an emission control communications link coupling the first and second communications platforms, wherein the network is adapted to provide multicast connections between the first platform and the second platform when the network is in an emission control (EMCON) state.

2. The network of claim 1 wherein the first communications platform includes a network interface proxy receiver coupled to a transmit side of the emission control communications link.

3. The network of claim 2 wherein the proxy receiver is adapted to forward multicast data over the emission control communications link to the second platform.

4. The network of claim 1 wherein the second communications platform includes a network interface proxy transmitter coupled to a receive side of the emission control communications link.

5. The network of claim 4 wherein the proxy transmitter is adapted to transmit multicast data to surface multicast members on the second platform.

6. The network of claim 1 wherein the emission control link is uni-directional.

7. The network of claim 1 further comprising a multicast address resolution server in each of the first and second platforms, each multicast address resolution server providing bi-directional communication in each of the first and second platforms.

8. A communications network comprising:
a first communications cluster; and
a second communications cluster, wherein the first cluster is coupled to the second cluster by an EMCON data link, wherein during EMCON operation, the first cluster is adapted to forward multicast data over the EMCON data link to the second cluster, and wherein the second cluster is adapted to transmit the data to surface multicast members.

9. The network of claim 8 wherein the first cluster includes a proxy receiver and the second cluster includes a proxy transmitter, and wherein the proxy receiver is adapted to forward the multicast data over the EMCON link to the proxy transmitter.

10. The network of claim 9 wherein the proxy transmitter is a member of a surface multicast address resolution server cluster.

11. The network of claim 9 wherein the proxy transmitter relays multicast data from the proxy receiver to the surface multicast members through asynchronous transfer mode switch connections.

12. The network of claim 8 further comprising a multicast source adapted to obtain a list of asynchronous transfer mode end addresses from the multicast address resolution server represent cluster members that have registered to receive the multicast data.
